(19) United States
(12) Patent Application Publication
(10) Pub. No.: US 2004/0267619 A1
(43) Pub. Date: Dec. 30, 2004

(54) Electronic transaction system

(76) Inventor: Gary Michael Watts, Calne (GB)

Correspondence Address: Cook, Alex, McFarron, Manzo,, Cummings & Mehler, Ltd., Suite 2850, 200 W. Adams Street, Chicago, IL, 60606, US

(21) Appl. No.: 10/867,509

(22) Filed: Jun. 14, 2004

(30) Foreign Application Priority Data
Jun. 12, 2003 (GB) 0313530.5

(51) Int. Cl. G06F 17/60

(52) U.S. Cl. 705/16

(57) ABSTRACT

A transaction system for tourist attractions comprises a plurality of merchant terminals 2 at respective attractions and a plurality of pass cards 4, 6. Each card 4, 6 is loaded with token which defines the attributes of the pass or passes provided by the card. Each merchant terminal 2 can write data to the cards to amend the tokens or to add new tokens.

The system allows customers to re-use existing cards at tourist attractions worldwide. Also, the system enables the activities of the customer to be controlled in accordance with their previous activities which are stored on the card.

### BACKGROUND OF THE INVENTION

1. Field of the Invention

The present invention relates to a transaction system and more particularly but not solely to a transaction system in which tourism pass cards are held by persons and used when entering attractions participating in one or more tourism schemes.

2. Related Background Art

It is known to run tourism schemes, in which persons are issued with tourism pass cards that may be used when visiting tourist attractions within a particular tourism scheme. One such system involves the use of simple pre-programmed memory cards (such as cards incorporating magnetic strips or electronic memory devices such as smart cards), which record the validity of the card prior to use, such that it can be checked on each use of the card at an attraction.

The information (the “Pass”) within the card memory is can be read and processed to determine if access to an attraction should be given to the card holder. As an example, a family wishing to visit a plurality of attractions in London over a 2 day period would purchase one 2 day card for each family member. The cards are then presented at each attraction, where the validity of the cards is checked before access is granted. At the end of the 2 day period, the cards are no longer valid and can be discarded.

The system suffers the drawback that one card is required by each customer for each visit that they make to a particular locality. This creates additional collateral and distribution expenses for tourism scheme operators. Another disadvantage is that the same card can be used to gain access to the same attraction more than once, thereby making it possible for customers to pass their cards back to others to gain access without the need for their own card.

We have now devised an arrangement which overcomes the limitations of existing transaction systems.

### SUMMARY OF THE INVENTION

In accordance with the present invention there is provided a transaction system comprising:

a plurality of merchant terminals each having a device for reading data from and writing data to a card; and

a plurality of multi-application cards arranged to store data and arranged to interact with said read/write device, each terminal being arranged to interrogate a card inserted into the card reader thereof to determine for the presence of a valid data token and to provide a pass indication in the event that a valid token is detected, the terminals being arranged to write tokens onto the cards and/or to vary the validity of existing tokens.

In use, a family wishing to obtain passes to visit a plurality of attractions in say London over a 2 day period would only need to purchase one card loaded with a token or containing details of the purchase, such as the time duration of the pass, the number, the location (e.g. London), the number of people and their status (e.g. child, adult, OAP etc). The passes may be ordered via the Internet. The card containing the token would then be mailed together with a guide book containing a list of the attractions at which the card is accepted.

Once at an attraction, the validity of the token is checked before access is granted by way of the pass indication. Also, once at an attraction, a customer will be able to purchase further passes or extend the duration of existing passes, and this is achieved by writing a-new token to the card or by amending an existing token.

In this manner, if the adults of the same family then visit Washington DC later in the same year, the same card can be re-used by paying for the required passes at the first attraction which they visit. Alternatively, the passes can be purchased over the Internet and loaded onto the card upon its presentation at the first attraction which they visit.

Upon each use of the card, details of the use are written to the card or stored remotely, which details can be interrogated to prevent re-use at the same attraction.

The system in accordance with the present invention therefore uses a passes and pass data residing on a smart card (e.g. that of a transport operator or), preferably together with information related to the current transaction, and customized business rules in order to evoke the Pass residing on the card to either allow entry to a facility or reject the Pass on the card and refuse entry.

The cards may be dedicated cards, alternatively the tokens and data may be written onto an area of the user's personal bank or identification card: many banks and financial institutions etc. already issue cards having this capability.

Preferably the token carries an expiry date, which may be an actual date in time, or which can be calculated as a predetermined number of days from first use of the card. Thus, the pass can be set to expire any number of days/hours/minutes from the first use or after a certain period of time(e.g. after a predetermined number of days or non-consecutive days from first use).

It will be appreciated that the business rules operated by the terminal can be tailored to make a vary the token in response to a predetermined usage pattern on the part of the card holder. In this manner, for example, the user could be prevented from visiting more than 2 art galleries in any one day.

Preferably, the token comprises one or more of the following data items:

a) A date of issue field comprising the date on which the issue took place;

b) A device ID field comprising an identification number or code for the terminals at which the card was processed;

c) An expiry field, defining the date on which the token expires or the length of time it remains valid;

d) A token duration defining the number of hours, days, months, 30 months, years the token is valid for;

e) A date of unused token expiry defining the ultimate expiry date for an unused token.

f) A scheme identifier defining the scheme (e.g. the location) at which the token can be used.

g) A number of pass profile identifiers defining the type of visitor (e.g. Adult, Child, VIP, Senior citizen, Student etc).

h) A digital signature to prove data authenticity of the card. The signature will preferably be a signed cryptographic hash (for example MD5) of Pass data, encrypted using an encryption algorithm and a set of keys. The exact nature of the algorithm will depend on the capabilities of the target card platform. RSA, 3DES and Elliptic Curve algorithms would all be applicable to such a signature.

I) A unique ID allowing a token on a card to be uniquely referenced for the purposes of pass update, upgrade, cancellation etc.

Preferably data is encrypted before it is written to the card.

Preferably the terminals are connected to each other via a networks. Preferably the terminals are connected to a central database arranged to manage and update or modify the business rules and financial reports for the respective tourism scheme.

Also in accordance with the present invention, there a method for providing access to the facilities of a tourist attraction, wherein an electronic memory card reader is used to selectively provide a person with access to, or deny the person access to, the facilities of a tourist attraction, according to data stored in the memory of a multi-application memory card presented by that person.

Further in accordance with the present invention, there is provided a tourism attraction having an electronic memory card reader for selectively providing a person with access to, or denying the person access to, the facilities of the tourist attraction, according to data stored in the memory of a multi-application memory card presented by that person.

Still further in accordance with the present invention, there is provided a business scheme, wherein data for providing access to a tourist attraction operated by a first business concern is stored on a multi-application memory card issued by a second business concern for at least one alternative purpose.

### BRIEF DESCRIPTION OF THE DRAWINGS

An embodiment of the present invention will now be described by way of an example only and with reference to the accompanying drawings, in which:

FIG. 1 is a schematic block diagram of a portion of a transaction system in accordance with the present invention;

FIG. 2 is a schematic diagram showing the Pass Directory used to give the location of passes and any related logs in the Pass Directory held in memory of a card used in the system of the present invention; and

FIG. 3 is a schematic diagram showing the Pass visit and Discount log structure held in the memory of the card used in the system of the present invention.

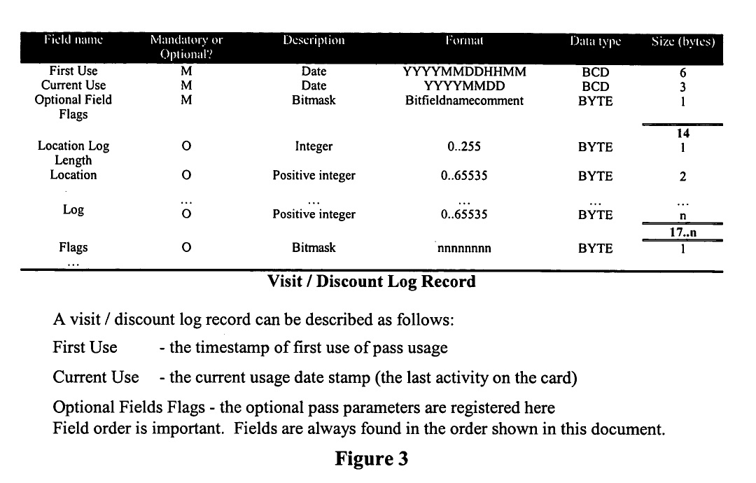

### DETAILED DESCRIPTION OF THE PREFERRED EMBODIMENT

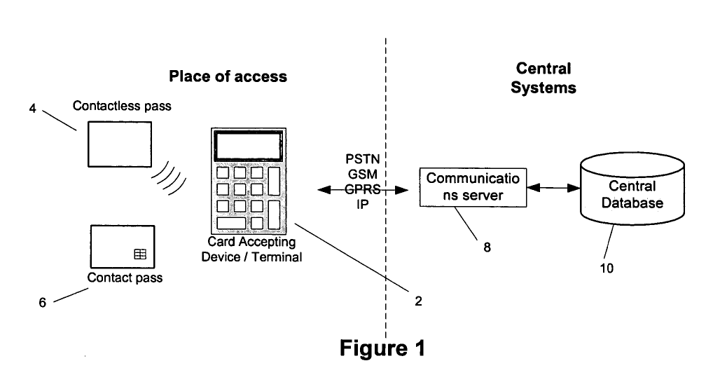

Referring to FIG. 1 of the drawings, there is shown an apparatus, provided at each entry point in a tourism outlet. The apparatus comprises a merchant terminal 2 having a device for reading and writing data to cards.

Each connected terminal 2 is connected to via a server 8 to a central database 10. The pass functionality at each terminal 2 may be incorporated into the terminal 2, such that the card read/write device may operate in an off-line mode. Alternatively, the pass functionality may be provided by the database 10 remote from the terminal.

The network may comprise an Ethernet, rs232 or wireless configuration, for example. The terminal apparatus 2 needs to communicate with any other servers which are central to the tourism scheme: this communication may be effected over a dedicated line (e.g. telephone line) or over the till network. The terminal apparatus 2 may, for example, comprise the MAGIC6100 unit marketed by the French company SchlumbergerSema the OMNI 3750 from the USA company Verifone or the 8550 unit marketed by the Australian company Intellect.

The card read/write device includes a card interface, a visual display and a printer (optional), in addition to a data processor and communications device.

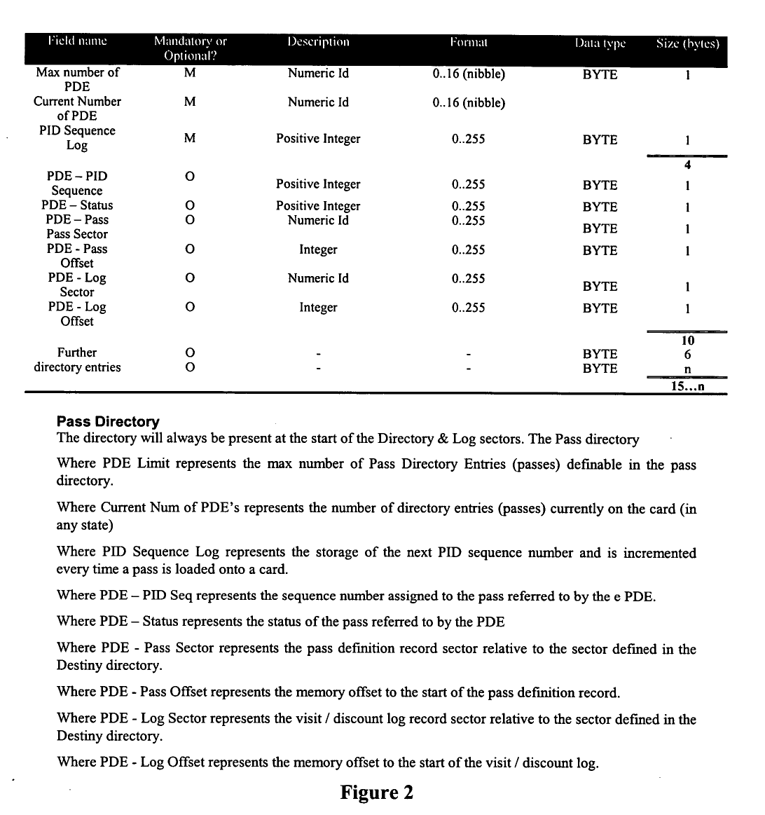

The system uses microprocessor cards 4, 6 held by customers wishing to use the scheme. In use, and at each new transaction, a card, e.g. 4, is presented to the terminal device 2, which reads the card. Should no pass application be present on the card, the card accepting device will, on demand, load a pass application onto the card. Once the pass application is present on the card, scheme and pass data (FIG. 2) can be loaded for processing in accordance with customized business rules. If the card holder wishes to use the Pass at the premises of trader participating in the scheme, a card accepting device 2 at those premises will read the Pass from the card 4, determine if the Pass is valid and write a code back to the card.

The tourism terminal or card accepting device 2 uses predetermined business rules to take into account the profile of the card holder and card 4 and the current transaction details recorded on the card, in order to determine whether access is to be permitted to a particular attraction. The terminal 2 holds a set of business rules which have been transmitted to it, via a communications server 8, from a central database 10. The particular set of rules can be limited in date and/or specific to specific days of the week and/or hours of the day. It is accordingly simple to formulate a set of rules which promote one attraction over another or a certain pass type within a certain time period.

The following represents, by way of an example, a set of business rules which may be operated by the terminal or CAD 2:

I) A card is inserted at the terminal, the card is checked as valid or not valid and verified as having the pass application on the card.

ii) If the card is valid but no pass application resides on the card, the customer will have the pass application loaded onto the card together with an appropriate ‘pass’ for use immediately or at a future date. This allows the card holder to have immediate redemption of the Pass at the traders outlet.

iii) Upon first use, the pass is activated and is only valid for the duration of the pass from that moment onwards (i.e. a 7 day pass would be valid for 7 days from the date of first use) and in accordance with the business rules in place for the card and scheme.

iv) Upon each use of the card, data in relation to the current transaction is captured by the terminal 2, which data typically includes card number, date of card visit, card type, card duration, scheme identifier. The terminal typically applies the predetermined business rules to process data relating to the current transaction to determine what action, if any, is to be taken, then to write corresponding data to the card and update the transaction.

The invention thus allows complete flexibility on the part of the trader participating in or running the tourism scheme. The Pass application and Pass Data can be resident on the third party cards thereby providing tourism scheme operators access to many more potential card holders.

By allowing the pass application and pass data onto their card, the card issuer will be able to offer existing card holders access to tourist attractions, thereby uplifting the value of owning the card to the card holder.

While the preferred embodiment of the invention has been shown and described, it will be understood by those skilled in the art that changes of modifications may be made thereto without departing from the true spirit and scope of the invention.

I claim:

1. A transaction system comprising: a plurality of merchant terminals each having a device for reading data from and writing data to a card; and
a plurality of multi-application cards arranged to store data and arranged to interact with said read/write device, each terminal being arranged to interrogate a card inserted into the card reader thereof to determine for the presence of a valid data token and to provide a pass indication in the event that a valid token is detected, the terminals being arranged to write tokens onto the cards and/or to vary the validity of existing tokens.

2. A transaction system as claimed in claim 1, in which at least one of said card is a bank card or identification card.

3. A transaction system as claimed in claim 1, in which said token comprises one or more of the following data items:
a) A date of issue field comprising the date on which the issue took place;
b) A device ID field comprising an identification number or code for the terminals at which the card was processed;
c) An expiry field, defining the date on which the token expires or the length of time it remains valid;
d) A token duration defining the number of hours, days, months, 30 months, years the token is valid for;
e) A date of unused token expiry defining the ultimate expiry date for an unused token.
f) A scheme identifier defining the scheme (e.g. the location) at which the token can be used.
g) A number of pass profile identifiers defining the type of visitor (e.g. Adult, Child, VIP, Senior citizen, Student etc).
h) A digital signature to prove data authenticity of the card. The signature will preferably be a signed cryptographic hash (for example MD5) of Pass data, encrypted using an encryption algorithm and a set of keys. The exact nature of the algorithm will depend on the capabilities of the target card platform. RSA, 3DES and Elliptic Curve algorithms would all be applicable to such a signature.
I) A unique ID allowing a token on a card to be uniquely referenced for the purposes of pass update, upgrade, cancellation etc.

4. A transaction system as claimed in claim 1, in which data is encrypted before it is written to the card.

5. A transaction system as claimed in claim 1, in which the terminals are connected to each other via a network.

6. A transaction system as claimed in claim 1, in which the terminals are connected to a central database arranged to manage and update or modify the business rules and financial reports for the respective tourism scheme.

7. A transaction system for tourist attractions comprising means, operable when a transaction system is affected, for:
executing a pass application on a multi-application card, which card stores records of a plurality of ‘pass’ permissions, ‘pass profiles’ (adult, child, OAP), types and previous transactions made by the ‘pass’; determining what, if any, access to an attraction is to be granted to the card holder;
enabling said card holder to reload the card with another pass profile, type and duration; and,
writing a code to said pass area in the card to identify said access conditions.

8. A transaction system as claimed in claim 7, in which said pass comprises a date of issue field comprising the date on which the pass issue took place.

9. A transaction system as claimed in claim 7, in which said pass comprises a device ID field comprising an identification number or code for the terminal at which the card was processed.

10. A transaction system as claimed in claim 7, in which said pass comprises a pass expiry field, defining the date on which the pass expires or the length of time it remains valid.

11. A transaction system as claimed in claim 7, in which said pass comprises pass duration defining the number of hours, days, months, 30 months, years the pass is valid for.

12. A transaction system as claimed in claim 7, in which said pass comprises date of unused pass expiry defining the ultimate pass expiry date for an unused Pass.

13. A transaction system as claimed in claim 7, in which said pass comprises a scheme identifier defining the scheme to which the pass belongs.

14. A transaction system as claimed in claim 7, in which said pass comprises a number of pass profile identifiers defining the type of visitor.

15. A transaction system as claimed in claim 7, in which said pass comprises a digital signature to prove data authenticity of the pass.

16. A transaction system as claimed in claim 15, in which said signature is a signed cryptographic hash (for example MD5) of pass data, encrypted using an encryption algorithm and a set of keys.

17. A transaction system as claimed in claim 16, in which said algorithm depends on the capabilities of the target card platform.

18. A transaction system as claimed in claim 7, in which said pass comprises a unique PASS ID allowing a pass on a card to be uniquely referenced for the purposes of pass update, upgrade, cancellation etc.

19. A transaction system as claimed in claim 7, in which said pass is written to a third parties card and comprises pre-determined logic values written to a dedicated area on the third parties card.

20. A transaction system as claimed in claim 7, in which data is encrypted before it is written to the card.

21. A transaction system as claimed in claim 7, in which the terminal apparatus stores data relating to each pass loaded or presented for subsequent transmission to a central database which is arranged to manage and update or modify the business rules and financial reports for the respective tourism scheme.

22. A method for providing access to the facilities of a tourist attraction, wherein an electronic memory card reader is used to selectively provide a person with access to, or deny the person access to, the facilities of a tourist attraction, according to data stored in the memory of a multi-application memory card presented by that person.

23. A tourism attraction having an electronic memory card reader for selectively providing a person with access to, or denying the person access to, the facilities of the tourist attraction, according to data stored in the memory of a multi-application memory card presented by that person.

24. A business scheme, wherein data for providing access to a tourist attraction operated by a first business concern is stored on a multi-application memory card issued by a second business concern for at least one alternative purpose.
